(19) United States
(12) Patent Application Publication
(10) Pub. No.: US 2026/0075143 A1
(43) Pub. Date: Mar. 12, 2026

(54) SYSTEMS AND METHODS FOR PROVIDING A VIRTUAL COMMUNICATION CENTER

(71) Applicant: SuccessKPI, Inc,, Centerville, VA (US)

(72) Inventors: David Rennyson, Centreville, VA (US); Praphul Kumar, Aldie, VA (US); Andrew Ren, Bridgewater, NJ (US); Franklin Zhu, Orlando, FL (US); James Rennyson, Centreville, VA (US); Anya Priyal, Aldie, VA (US)

(73) Assignee: SuccessKPI, Inc., Centreville, VA (US)

(21) Appl. No.: 19/325,407

(22) Filed: Sep. 10, 2025

Related U.S. Application Data
(60) Provisional application No. 63/693,102, filed on Sep. 10, 2024.

(51) Int. Cl. H04M 3/51

(52) U.S. Cl. CPC H04M 3/5175; H04M 3/5191

(57) ABSTRACT

Systems and methods are provided for monitoring and managing call center operations within a virtual reality environment. A processing system generates a virtual call center comprising virtual workstations associated with respective agents. Each workstation includes a monitor displaying call information, a call health panel presenting real-time call status, and an agent health panel presenting agent condition or performance data. The system receives call audio and related data, performs transcription and signal analysis, and applies machine learning models to determine call sentiment, agent status, and recommended actions. Based on the analysis, the system dynamically updates the virtual reality environment, including visual indicators, supervisor alerts, and interactive panels. Supervisors may navigate the environment, monitor multiple agents, and interact with calls using virtual tools such as notes, scoring, or intervention modes. The disclosed embodiments improve real-time awareness, training, and decision-making in contact center environments.

### CROSS REFERENCE TO RELATED APPLICATIONS

This application claims priority to and the benefit of U.S. Provisional Patent Application No. 63/693,102, filed on Sep. 10, 2024, titled “System and Method for Providing a Virtual Communication Center,” the entire contents of which are incorporated herein by reference.

### FIELD OF THE INVENTION

The disclosure relates generally to call center management systems, and more particularly to systems and methods for monitoring, analyzing, and interacting with call agents through a virtual reality call center environment.

### BACKGROUND

The present disclosure provides systems and methods that relate to a communication center environment, such as a call center environment.

In a communication center environment, as is the case with many work environments, collaboration between workers is often viewed as being highly beneficial. Such collaboration between workers can be performed over a wide variety of communication channels. Such communication channels can include face-to-face, audio only, and a combination of audio and video, for example.

Research has been established that face-to-face interactions have widely been considered as the best medium to provide a highly effective collaborative environment. However, with the arrival of the Covid-19 pandemic, companies and other entities were required to adapt to visual channels in lieu of face-to-face interactions. Such visual channels often involve one or more video conferencing tools.

However, there are fundamental issues with videoconferencing tools that can affect clear communication between users. For example, a user is often unable to interpret important visual cues over videoconferencing. Given that cameras may primarily capture only the upper portion of an individual's body, significant elements of a person's physical context remain unseen. Consequently, this leads to a sub optimal understanding of a communication partner's nonverbal signals. This dynamic can lead to decreased productivity.

Another fundamental issue with videoconferencing tools can be the quality and amount of data that is available to the various workers. This can include the quality and amount of data available to a supervisor who has various workers under their supervision. Relatedly, this can also include the quality and amount of data available to such workers. For example, in a videoconference environment, a worker can be limited in the amount of information available to them to effectively perform their job. Also, a worker can be limited in the amount of information available to them to effectively inform the worker if they are doing a good job or a poor job.

Accordingly, there remains a need for improved systems and methods that generate a virtual call center environment in which supervisors can monitor, analyze, and interact with many agents and calls dynamically, using real-time data, predictive analytics, audio indicators, and visual indicators.

### SUMMARY OF THE INVENTION

The disclosure is directed to and relates to a call center system displayed and interactive in a virtual reality environment (VRE), allowing a user or supervisor to engage with call agents, the phone calls the agents are engaged in. The system uses proximity location of the agents to place phone calls in the VRE and the location of the supervisor in the VRE to identify which calls the supervisor can hear among other features.

The disclosed embodiments provide systems, methods, and computer-readable media for monitoring and managing call center operations within a virtual reality call center environment (“VRE” or “VRCCE”). A processing system generates a virtual call center comprising a plurality of virtual workstations, each associated with a call agent. Audio data from active calls is spatially mapped to the positions of the corresponding virtual workstations, enabling a supervisor to navigate the environment (VRCCE) and hear calls based on the supervisor's virtual position or proximity relative to the virtual workstations or agents, thereby replicating the experience of physically walking a call center floor.

In some embodiments, the system dynamically reconfigures the layout of virtual workstations based on real-time analysis of calls, agent performance, supervisor preferences, or commands, allowing supervisors to group agents requiring assistance for focused monitoring or training. The system may further generate visual panels associated with the workstations, including call health panels displaying real-time call information and agent health panels displaying agent status or condition data. The disclosed embodiments enhance real-time awareness, provide intuitive supervisory tools, and improve decision-making in distributed call center environments.

The system also receives call audio and related data, performs transcription and analysis, and applies machine learning models to identify sentiment, classify problems, and determine recommended actions. Based on this analysis, the virtual environment is dynamically updated to include visual indicators, supervisor alerts, and interactive panels. Supervisors may navigate the environment, observe multiple agents simultaneously, and interact with calls using virtual tools such as note placement, scoring, coaching, or intervention modes. By providing an immersive and data-driven interface, the disclosed embodiments enhance real-time awareness, training, and decision-making in contact center environments.

### BRIEF DESCRIPTION OF THE DRAWINGS

FIG. 1 is an illustrative example of a virtual call center environment having call agents and virtual workstations.

FIG. 2 illustrates a system architecture including a processing system, network, and virtual agent components.

FIG. 3 illustrates a block diagram of a virtual reality environment (VRE) system builder for a virtual reality call center and associated databases.

FIG. 4 illustrates a flow diagram for generating and managing a virtual reality environment for a virtual reality call center.

FIG. 5 illustrates a flow diagram of call monitoring, analysis, and updates in a virtual reality call center environment.

FIG. 6 illustrates a flow diagram of the integration of problem profiles and action profiles analysis in a virtual call center system.

FIG. 7 illustrates an agent virtual workstation with an associated call status display.

FIG. 8 illustrates a virtual workstation monitor within a virtual workstation displaying agent notes and call information.

FIG. 9 illustrates a virtual workstation monitor with a virtual workstation displaying analytical charts and visualizations.

FIG. 10 illustrates a system block diagram of problem analysis, profile and action generation and implementation within a virtual call center environment.

### DETAILED DESCRIPTION OF THE INVENTION

The present disclosure provides systems and methods that relate to a communication center environment, such as a call center environment. More specifically, the systems and methods of the disclosure provide real-time agent assist capabilities and real-time call monitoring capabilities, using various innovative technologies, in a re-imagination of a communication contact center. In such a contact center, agents can reach out to customers in a wide variety of scenarios. In accordance with the disclosure, one or more supervisors, who oversee the agents, can be connected to the agents using various innovative technology in a virtual reality environment. The systems and methods of the disclosure can be described as a “data processing and interface” (DPI) system.

Collaboration between workers is often viewed as being highly beneficial. Such collaboration between workers can be performed over a wide variety of communication channels. Such communication channels can include face-to-face, audio only, and a combination of audio and video, for example.

Research has been established that face-to-face interactions have widely been considered as the best medium to provide a highly effective collaborative environment. However, with the arrival of the Covid-19 pandemic, companies and other entities were required to adapt to visual channels in lieu of face-to-face interactions. Such visual channels often involve one or more video conferencing tools.

However, there are some fundamental issues with videoconferencing tools that can affect clear communication between users. For example, a user is often unable to interpret important visual cues over videoconferencing. Given that a camera may primarily capture only the upper portion of an individual's body, significant elements of a person's physical context remain unseen. Consequently, this leads to a sub optimal understanding of their communication partners nonverbal signals. This dynamic can lead to decreased productivity.

The offset between a screen and camera can make it difficult to establish where focus is intended. Eye contact is important for conversations as we are able to sense how engaged our partner is. On a video call, not knowing whether someone is paying attention can affect the confidence of a communicator, and lead to decreased morale.

Further, time delay between responses can interfere with the overall flow of a conversation. Enduring instances of uncomfortable silence while awaiting a reply can diminish the collective energy of a group. This dynamic can potentially impair effective communication between the members of a group.

The DPI system of the disclosure provides a virtual reality (VR) work environment that offers promising solutions to the various challenges posed by traditional videoconferencing. As described below in detail, the DPI system has a capacity to observe and act on, through various technology described herein, nonverbal behaviors, including gaze direction, gestures, postures, and in facial expressions, for example.

The DPI system can enhance the realism of interactions between agents and their supervisors, in conjunction with fostering better communication and diagnostics of observed behavior and interactions. The DPI system can effectively eliminate the awkward silences associated with toggling the mute function and questioning whether it is your turn to speak. Additionally, the DPI system can provide the opportunity to implement shared physical interfaces inside of the workspace. As result, coworkers can use “deictic utterances” such as that, those, they are when referring to objects, data, or interfaces inside of a 3D space. This capability can effectively reduce the usage of longer descriptions such as “over your cursor over the hamburger button under the navigation bar on the left”. The DPI system can improve the quality of the experience with more efficient language. Further, by leveraging the development of the Apple Vision Pro technology and various other technology in the virtual reality (VR) industry, the DPI system of the disclosure can provide a highly efficient and effective platform that can reshape how virtual contact centers operate, as compared to traditional contact centers.

The DPI system of the disclosure can include, in accordance with one aspect of the disclosure, a virtual supervisor and a plurality of virtual agents that are associated with the virtual supervisor. The virtual supervisor, of the DPI system, can serve to replicate the human connection of a physical contact center, but inside of a virtual reality realm. Various technical innovations, as described herein, are provided in the disclosure so as to provide such capabilities. The DPI system merges the strengths of in person contact centers with the power of innovative interfaces equipped with various data processing capabilities. The DPI system of the disclosure empower supervisors to more efficiently and effectively interface with the agents that are under the supervisor's control, and allows the supervisor to make better informed decisions for the various agents that make up the supervisor's team.

In accordance with one aspect of a system of the disclosure, a supervisor can sign into their virtual contact center. Upon signing in, the supervisor can hear the buzz of the agents engaging in conversation. The supervisor can effectively “walk” the virtual space. Through hearing different voices and snippets of various conversation, the supervisor can immediately, in an efficient and effective manner, gauge the general state of the call center.

As calls continue to occur around the supervisor in the virtual space, visual emotes can appear above the “avatar agents”, so as to be visible to the supervisor. The visual emotes can signal, to the supervisor, the current issues that each of the agents are navigating. For example, a speech and analytics tool can discern an agent grappling with a customer attempting to cancel their subscription. Based on data available to the DPI system, the DPI system can trigger a red emote, for example, featuring a cancellation symbol. Such visual emote can be displayed above the avatar agent. The generation of such visual emote can be based on various data including analysis of the tone of the conversation between the particular agent and the customer, as well as an analysis of the particular words being spoken by the customer and the agent.

Based on such information made available to the supervisor, the supervisor can then drill into the particular interaction between the agent and the customer. The supervisor can offer the necessary support for the agent. Not only can a supervisor support an agent during stressful situations, the supervisor can also publicly command an agent for exemplary performance, for example. Through real-time audio playback, a supervisor can tell whether an agent has vibrant energy during interactions, and ultimately broadcast their efforts. Such positive reinforcement not only motivates the individual agent, but also helps inspire the entire team by cultivating a culture of appreciation, accountability, and positivity.

It is appreciated that some supervisors may prefer the familiarity of a traditional 2D interface. The DPI system addresses and accommodates this preference by enabling users to open up “windows” inside of the virtual world, such as using a dashboard as described below. For example, if a supervisor wants to view an agent's performance over the agent's last 15 calls, the supervisor can click a button adjacent to the agent's avatar cubicle space. As a result, the DPI system can open a window, visible to the supervisor, that displays the desired information. The supervisor can be provided access to a wide variety of 2D interfaces, helping the supervisor maximize their productivity inside this new world. The supervisor is also provided the ability, by the DPI system, to interact with a virtual phone set, to barge into an ongoing call, or listen in to hear both sides of a conversation between a particular agent and a customer to which the agent is talking.

### Supervisor/Digital Assistant

The DPI system can harness the power of artificial intelligence and machine language technology to transform every conversation into insight. With the rise of natural language processing tools such as ChatGPT, the DPI system can train artificial intelligent (AI) bots with large and complex data sets, all focused on improving productivity in the contact centers. In accordance with processing of the disclosure, supervisors can have access to a personal AI assistant. The personal AI assistant can collect and process data specific to the particular supervisor's agents at real time speeds. The personal AI assistant can ultimately provide concise recommendations for the next course of action, given a particular situation.

### Real-Time Agent Visual Feedback

In accordance with the processing of the systems of the disclosure, as agents have conversations with customers, the DPI system can be running topic detections and scoring themes, as well as generating actions. Within the virtual realm provided by the DPI system, the DPI system can display identified insights as visual emotes floating above an agent's avatar. For example, if an agent is bombarded with inappropriate language from a customer, a visual Emote symbolizing or representing “being cursed at” could pop up above the particular agent's avatar. Then, the supervisor can notice this visual cue and come to support the particular agent. The DPI system can utilize speech and analytics technologies to input and analyze observed behavior and, in response, generate a plethora of emotes that symbolize different messages and requests.

### Real Time Spatial Audio Feedback

It is appreciated that there may be a concern that virtual call centers lack the organic hum of activity present in physical office spaces. However, audio technology can be provided to bridge the sensory data. Specifically, spatial audio can provide dynamic head tracking to create an immersive audio experience. The DPI system can employ this technology to allow supervisors to be attuned to conversations happening in real time, so as to create an auditory experience similar to that experienced in a physical presence in an office setting. The volume of agent conversations can be dependent upon the virtual proximity between the supervisor and the agent. That is, as the supervisor moves further away from a particular agent, in the virtual environment, the DPI system can decrease the volume of the “feed” coming from that particular agent to the supervisor. This added layer of realism provides a supervisor a more holistic understanding to gauge the call centers overall state. Additionally, the supervisor can have the ability to isolate individual conversations in case a particular agent needs support. In this evolving landscape of virtual collaboration, spatial audio technology can empower supervisors to seamlessly “plug into” conversations as needed, echoing the accessibility of a traditional office environment.

### Metaverse Technology Landscape

In recent years, virtual reality has been a rapidly growing technology with a wide variety and range of applications. From gaming to healthcare, many new industries have adapted VR to discover new opportunities. Not only are businesses taking advantage of new technologies, standalone headsets like the Apple Vision Pro or Oculus Quest 2 are becoming increasingly popular due to its affordability and accessibility. It is appreciated that other new technology is being developed that can be leveraged and utilized by the DPI system of the present disclosure.

The DPI system of the disclosure can generate a 3D virtual office space, complete with avatars for agents and avatars for supervisors. The DPI system can offer an immersive and interactive experience where a user, and in particular a supervisor can walk the “floor”. The virtual environment can provide different “queues” or “cubes” that can be accessed by a supervisor. Each cube can be a dynamically created floor. The dynamically created floor can represent working agents, not logged in agents, and idle agents, for example. The number of floors and/or the number of cubes can be dynamically generated spaces so as to accurately represent, and be commensurate with, what would be expected in a real physical environment. The particular form of the virtual queues, i.e. the working space, and the particular form of the agent avatars and the supervisor avatars can vary in form. Such variance in form can be dependent on the particular technology used to provide the virtual environment including the sophistication of such technology. For example, the agent avatars and supervisor avatars can be cartoonish and/or basic in form—if a less sophisticated processing technology is used to provide the virtual environment. On the other hand, agent avatars and supervisor avatars can be very lifelike and “neo-human” avatars if a more sophisticated processing technology is used to provide the virtual environment of the disclosure. Accordingly, it is appreciated that the various processing innovations of the disclosure can be used in less sophisticated or more sophisticated virtual environments.

The DPI system of the disclosure can provide spatial audio integration. That is, the virtual environment provided by the DPI system can use enriched spatial audio technology, enabling dynamic head tracking to simulate a realistic audio experience similar to that experienced in a physical office space. Such an experience might include walking from cube to cube, entering a cube, and joining a call (between an agent and a customer) by plugging in at the agent workstation.

The DPI system of the disclosure can provide real-time audio integration. In the processing of the DPI system, an agent can log into and connect with the DPI system, such as at the beginning of the agent's shift. Once the agent is connected to the DPI system, the agent can start working. In particular, the agent can tap a suitable button or otherwise interface with the DPI system, so as to indicate to the DPI system that the particular agent wants to retrieve a call. Thereafter, the agent is placed on a call with the next customer. The DPI system inputs various data regarding the call, in real time as the call is going on. The DPI system may also use any of a wide variety of other data available to the DPI system. For example, the particular customer may have entered her selection, in conjunction with the customer's on-boarding to set up the call, regarding the nature of the customer's call. The selection, for example, can be used as further data in the processing of the call between the customer and the particular agent.

The DPI system can provide various processing capabilities. The DPI system can enable real-time topic detection, theme scoring, and action generation, and use input data to generate and display scorecards for agents in real time. The DPI system can include a library of emotes for avatars to display real-time in app embedded 2D recreations or Grids. The DPI system can generate visualizations in real time based on observed data. For example, if a customer raises their voice at a particular point in time, the DPI system can identify the occurrence of such event, and map such event to a particular visual emote. That visual emote can then be displayed above the agent's avatar in the virtual environment. The supervisor can then see such visual emote from the perspective of the supervisor's observed virtual environment. The supervisor is, as a result, given information that the supervisor can act on—in an efficient and effective manner.

The DPI system can also generate agent scorecards. More specifically, the DPI system can aggregate a variety of data based on observed activity. The DPI system can then map such variety of data to a data table, so as to associate the observed activity with representative score points or points. Based on such processing, the DPI system can generate agent scorecards. The agent scorecards can represent the agent's overall activity and/or the agent's activity in a particular performance area.

The DPI system can include virtual “clipboards” to score call(s) of a particular agent or a group of calls, for example. The DPI system can generate and provide an interface via which a supervisor can select options for a clipboard. The supervisor can be provided with the option to select a particular call or calls to which the clipboard will represent. The supervisor can be provided with options as to what categories or aspects of the call that will be provided on the clipboard. For example, the clipboard might include categories such as knowledge of working policies of the company, effectiveness with dealing with the customer, and/or efficiency with resolving the customers concerns, for example.

The DPI system can generate and provide what can be described as “Life 360 reviews”.

The DPI system can provide machine scoring overlay and playback processing. For example, the DPI system can observe different attributes over the course of a call. The different attributes that can be observed might be particular choice of language that the agent uses, the intonation and manner of the agent to the customer, the particular direction that the agent chooses to lead the conversation, and/or the particular options that the agent proposes to the customer during the course of the call. The DPI system 200 can observe such attributes based on triggers. That is, if the DPI system observes a certain sequence of events, then a particular trigger may be triggered. Such observed attribute will then be mapped into a particular score in a particular category, for example. The DPI system can overlay one or more scores in sync with a playback of the call. That is, the DPI system can generate a presentation in which the call is played back and attributes that were scored, for the call, are displayed on a dynamic basis. In particular, the score of a particular attribute can vary over time as the dynamics of the call vary over time.

The DPI system can provide “joint coaching sessions.” The joint coaching sessions can be provided in a virtual environment between a supervisor and selected agents, for example. A particular coaching session can be directed to a particular category or attribute of the call. The DPI system can identify agents, based on their scorecard history, that could use help in a particular category. Accordingly, the agents that need help in a particular category can be identified—and a joint coaching session can be generated for those agents and their respective supervisor.

The DPI system can provide a feature described as “face the agent”. The face the agent feature allows a supervisor, or alternatively another agent, to “step into the shoes” of a customer so as to be a “mock” customer. The mock customer can interface with a select agent, so as to simulate a call interaction between a real customer and the select agent. Such a simulation can allow the mock customer, who is in fact an agent or supervisor, to experience the interaction with the select agent. Such simulation can give the mock customer and the select agent a sense of empathy, how it is to hear particular words, the experience of observing body language “behind” the call, and the opportunity to experience other dynamics of the call in a real-life type environment.

The DPI system can also include “instant rewards”. The instant rewards feature can include the DPI system being programmed to identify certain attributes, sequence of attributes or collection of attributes, that should be rewarded. The DPI system can then map such observed attributes to a particular reward. Such reward can then be awarded to the agent. For example, the DPI system might observe attributes from the customer that indicates that the customer wants to cancel a policy. The DPI system can then observe, through attributes, that the end result of the particular call resulted in the customer renewing their policy. Accordingly, such observed sequence of attributes can result in a reward being awarded to the agent. It should of course be appreciated that the nature and size of the reward can vary between the particular sequence of events and the particular nature of the situation.

The DPI system can also include a “hyper jump” feature. The hyper jump feature can allow a supervisor to jump between different agents, different offices, different floors, and/or otherwise jump or transition between different virtual spaces in the virtual environment. Some hyper jumps may be dictated by the supervisor and at the supervisor's discretion. Some hyper jumps may be system driven. That is, for example, if the DPI system observes certain behavior, through the observation of certain attributes, the DPI system can then map such observed attributes to an action item. One of the action items can be-that the supervisor is hyper jumped to the particular call. For example, if the DPI system observes attributes that indicate that the particular call is going in a bad direction, the DPI system can hyper jump the supervisor onto such call. It is appreciated that various triggering mechanisms and/or other observed attributes can trigger or result in a supervisor being hyper jumped to a particular call.

Hereinafter, various further features of the systems and methods of disclosure will be described with reference to the drawings.

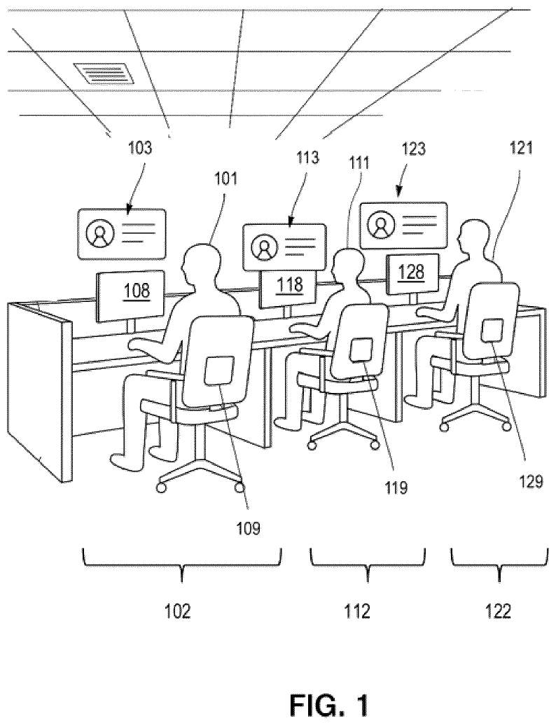

FIG. 1 is a schematic diagram of a virtual call center environment that can be generated by the DPI system, in accordance with at least one embodiment of the disclosure. The virtual environment includes a number of virtual agents 101, 111, 121, each seated within a virtual workstation 102, 112, 122. The virtual environment can also include additional virtual agents, and it is appreciated that the virtual environment may include any number of virtual agents 101, 111, 121 as may be desired. In this illustrative example, agent 101, 111 and 121 are assigned to a particular virtual supervisor. The particular number of agents 101, 111, 121 assigned to one supervisor can vary based on a variety of parameters. The number of agents assigned to a single supervisor can be three agents as shown in FIG. 1, or alternatively 5 agents, 10 agents, 20 agents, 30 agents, or any other number of agents as may be desired. The number of agents 101, 111, 121 per supervisor can depend on the complexity and the nature of the product or service the virtual agents 101, 111, 121 are handling.

As shown in FIG. 1, each virtual work station 102, 112, 122 allows a respective virtual agent 101, 111, 121 to interface with the customer via a customer-agent interface 108, 118, 128. The customer-agent interface 108, 118, 128 can include any number of user interface devices or methodologies including a virtual reality (VR) headset with both visual and audio capabilities, a keyboard, a mouse, a video monitor and/or any other user interface as may be desired.

Each workstation 102, 112, 122 for a respective virtual agent 101, 111, 121 can include a call health visual display 103, 113, 123. The call health visual display 103, 113, 123 can display various attributes regarding an ongoing call. For example, a green dot can be displayed on the call health visual display 103, 113, 123 if the call is going well. On the other hand, a red dot could be displayed on the call health visual display 103, 113, 123 if the call is not going well. In the virtual environment, the supervisor can observe a red dot for example, and hyper jump, walk to, or in some other way virtually approach the virtual agent 101, 111, 121 so as to assess the dynamics and disposition of the ongoing situation. It is appreciated that any of a wide variety of graphical representations can be used so as to convey different attributes of the call. For example, a yellow dot can be displayed when the DPI system senses that the call is moving towards conclusion of the call. Any number of graphical representations can be used. Also, the graphical representations are not limited to necessarily color. Particular shaped objects or icons can be used to represent the status of a particular attribute in a call. Also a combination of shapes and colors can be used to represent a particular attribute or ongoing situation in a call. The call health visual display 103, 113, 123 is not limited to shapes or colors. That is, as shown, various text, data, or other indicia can be used so as to convey attributes of the call.

Each workstation 102, 112, 122 for a respective virtual agent 101, 111, 121 can include an agent health visual display section 109, 119, 129. The agent health visual display section 109, 119, 129 can display various attributes regarding the particular virtual agent 101, 111, 121 over the course of the call. Any of a wide variety of colors and/or shapes can be used so as to represent the health of the agent 101, 111, 121, and so as to convey that health (of the agent) to the supervisor in an efficient and effective manner. To explain further, it is appreciated that even though a call is going badly (resulting in a possible red dot to be displayed on the call health visual display 103, 113, 123), the agent 101, 111, 121 may be handling the situation in a professional and effective manner. Accordingly, the agent's health visual 109, 119, 129 may be green, even though the call health visual display 103, 113, 123 is red. The agent health visual 109, 119, 129 is not limited to shapes or colors. Rather, various text, data or other indicia can be used so as to convey attributes of the agent's disposition over the course of the call.

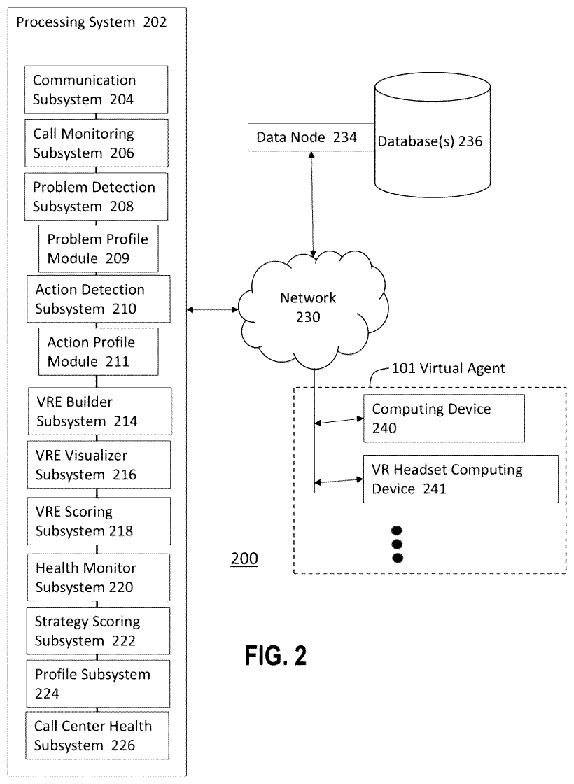

FIG. 2 is a block diagram showing a DPI system 200 in accordance with at least one embodiment of the disclosure. The DPI system 200 can include a processing system 202 and database 236. The processing system 202 can perform various processing as described herein. The database 236 can store various data used by the processing system 202 and/or generated by the processing system 202.

The DPI system 200 can also include, as shown in FIG. 2, a computing device 240 and a VR headset computing device 241, i.e. a VR headset 241. Both the computing device 240 and the VR headset computing device 241 can be associated with a virtual agent 101. For example, the computing device 240 can be a personal computer or laptop computer that is dedicated to a virtual agent 101. Also, the VR headset computing device 241 can be dedicated to the particular virtual agent. For example, the VR headset 241 can be connected and supported by the computing device 240, so as to leverage the processing of the computing device 240. FIG. 2 shows computing device 240 and VR headset 241 that can be dedicated to a specific virtual agent 101. However, it is appreciated that the system may of course include many additional computing devices 240 and VR headsets 241, so as to support additional virtual agents.

The DPI system 200, as shown, includes a network 230. The network 230 provides data communication between the various components of the DPI system 200 including the processing system 202, the database 236, the computing device 240 of the agent, and the VR headset 241 of the agent. Accordingly, the network 230 can provide communication with various other components including additional third-party resources, for example. Any of the components shown in FIG. 2 can be connected to network 230 utilizing suitable data nodes. For example, FIG. 2 shows data node 234 that is connected to database 236.

With further reference to FIG. 2, the processing system 202 can include various processing components as shown in FIG. 2. The processing system 202 can include communication subsystem 204. The communication subsystem 204 can handle a variety of processing relating to providing communication between the various components of the DPI system 200.

The call monitoring subsystem 206 can monitor the content of calls and perform predetermined action when certain attributes are identified in a call. For example, if the call monitoring subsystem 206 identifies that particular language or a particular word has been spoken in a call, the call monitoring subsystem 206 can map that particular word into a lookup table or other data associative mechanism. The particular word can be mapped to certain action. Accordingly, the DPI system can execute the particular action that was identified based on the mapping.

The problem detection subsystem 208 can be provided to identify a wide variety of problems that can occur in the system. Specifically, the problem detection subsystem 208 can monitor attributes of a call so as to identify problems occurring in the call. That is, observed attributes can be mapped to action items to be performed, upon the observation of a particular attribute. Such mapping can be performed by a problem profile module 209. Further, the attributes can be identified by an action detection subsystem 210.

The processing system 202 can also include an action profile module 211. In accordance with one embodiment of the disclosure, the action profile module 211 can observe certain attributes of a call, and recommend certain action to be taken by the agent in response to an observed situation. That is, attributes that might be observed in a call can be mapped to action to be taken, upon observation of such attributes.

The processing system 202 can also include a virtual reality environment (VRE) builder subsystem 214. The VRE builder subsystem 214 can perform various processing to “build out” the virtual reality environment over time. For example, the VR builder subsystem 214 can input data on an ongoing basis and anticipate likely outcomes based on such data. In the situation that the anticipated outcome is not observed, then the VRE builder subsystem can adjust weightings, thresholds, priorities, and/or other processing data so as to better “tune” the system to a situation—so as to better and more accurately anticipate the outcome of the situation. For example, if the VRE builder subsystem 214 observe certain attributes representing that a customer wants to cancel her subscription, the DPI system might suggest action to be taken so as to avoid such cancellation. If the customer still cancels her subscription, then the recommended action was incorrect or deficient. Accordingly, the VRE builder subsystem 214 can, over time, adjust attributes so as to avoid an unexpected outcome.

The processing system 202 can also include a VRE visualizer subsystem 216. The VRE visualizer subsystem 216 can input data representing observed attributes occurring in a call and map such observed attributes to visual representations, which are representative of the observed attributes. For example, the VRE visualizer subsystem 216 can observe attributes that are indicative that a call is going badly. The VRE visualizer subsystem 216 can then map those attributes to a particular color, for example, to display on the call health visual 105. For example, if the VRE visualizer subsystem 216 observes attributes indicative that the call is going poorly, the VRE visualizer subsystem 216 can output data to the call health visual 105 to display a red dot.

The processing system 202 can also include a VRE scoring subsystem 218. The VRE scoring subsystem 218 can input select data and generate scores based on such select data. For example, the VRE scoring subsystem 218 can observe attributes during a call and observe the outcome of the particular call. The VRE scoring subsystem 218 can then generate a score based on such input attributes.

The processing system 202 can also include a Health Monitor Subsystem 220 which can monitor the health or other characteristics of the agents. The Health Monitor Subsystem 220 is used to monitor, compile and determine various health related metrics which can be displayed on the agent health monitor display 109, 119, 129.

The processing system 202 can also include a strategy scoring subsystem 222. The strategy scoring subsystem 222 can observe the application of a strategy that is suggested and/or implemented in a particular call scenario. The strategy scoring subsystem 222 can then analyze the input and the outcome of the call. Based on the outcome of the particular call, the strategy scoring subsystem 222 can assign a score to the particular strategy that was implemented. Specifically, the score can depend on whether the strategy was effective or not effective.

The processing system 202 can also include a profile subsystem 224. The profile subsystem 224 can generate profiles for both agents and supervisors. The profile subsystem 224 can also generate profiles for customers. Based on attributes of a particular profile, different action can be taken. For example, if the profile of an agent aligns with certain data, then that agent might be assigned a particular type of customer. Relatedly, a customer of a particular profile might be matched to an agent of a particular profile. In this manner, the human strengths of a particular agent might be leveraged to deal with a particular type of customer.

The processing system 202 can also include a call center health subsystem 226. The call center health subsystem 226 can observe attributes across some or all of a call center. In particular, the call center health subsystem 226 can collect and aggregate attributes across a group of agents in a call center and/or supervisors that are associated with the group of agents. Based on such collected data, the call center health subsystem 226 can determine or assign one or more scores to the call center. The one or more scores can include an overall score as well as scores in different areas of performance.

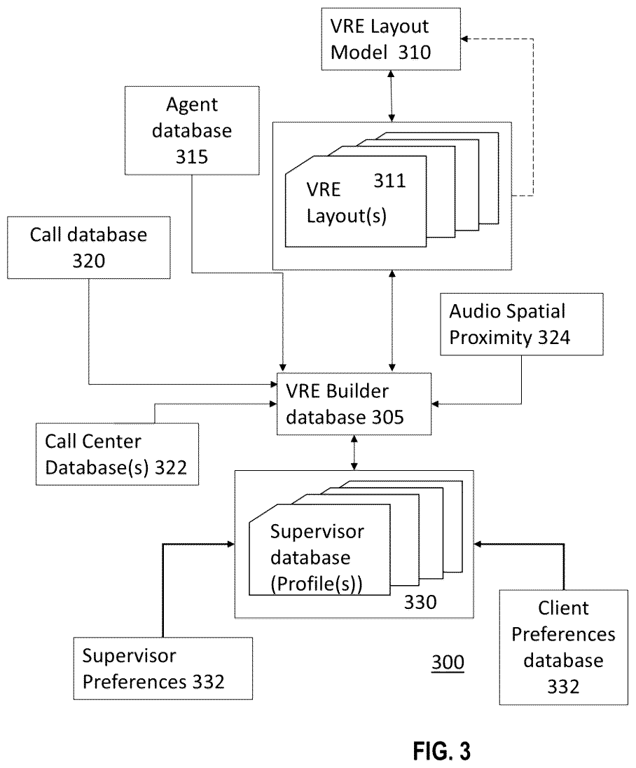

FIG. 3 is a schematic diagram of a database architecture 300 that may be used in the DPI system 200, in accordance with at least one embodiment of the disclosure. For example, the database architecture 300 can be used in the database 236. The database architecture 300 can include various components.

A VRE layout model 310 can include one or more data sets to generate a particular layout for a virtual environment. For example, the VRE layout model 310 can input attributes regarding a particular desired virtual environment. For example, the processing system 202 can input data indicating that a virtual call center is to include 5 agents associated with one supervisor. The VRE layout can be used by the processing system 202 to generate such a virtual environment. The VRE layout 311 can map an input number of agents to an appropriate virtual environment that corresponds to such input number of agents. Relatedly, the VRE layouts 311 can include a variety of data that can generate a particular type or theme a virtual environment. For example, the VRE layout model 310 can create a virtual environment with three offices that correspond to an input number of three agents. The VRE layouts 311 may then provide data to provide different options for a theme for such three offices.

The database architecture 300 can also include an agent database 315. The agent database 315 can contain various data relating to agents associated with the virtual environment.

The database architecture 300 can also include a call data database 320 and call center database 322. The call data database 320 and call center database 322 can store a wide variety of data generated by and used by the DPI system 200 including historical call data, call center agents, customers, scripts or playbooks, and other data.

The database architecture 300 can include a supervisor database 330. The supervisor database 330 can include various data regarding each of the supervisors associated with the particular virtual environment. In particular, the supervisor database 330 can include profile data regarding each of the supervisors. Further, the database architecture 300 can include supervisor preferences 332. The supervisor preferences 332 can store various data regarding preferences of the particular supervisor. Such preferences can include what data that a supervisor wants to see, i.e. opts to see, in the supervisor's virtual environment. The supervisor can be given the option of whether to see some types of data and not other types of data. For example, if a supervisor is experiencing a certain type of call in a call center or a certain nature of call, then the supervisor might opt to see particular data relevant to such certain nature of call. Further, the supervisor might vary the graphical representations that are used to convey information. For example, if a supervisor is colorblind, that supervisor might use shapes to represent the status of a call, as opposed to using color to represent the status of a call.

The database architecture 300 might also include a client preferences database 332. The client preferences database 332 can contain data that is unique to a particular client. That is, a virtual environment call center of the disclosure can service different clients. The protocols and policy can differ between different clients. Accordingly, if certain attributes are observed in a call, the recommended action to be performed in response to such attributes might be different for a first client as opposed to a second client. In general, a wide variety of client preferences can be stored in the client preferences database 332.

As shown in FIG. 3, the various databases and data sets of the database architecture 300 can “feed” into a VRE builder database 305. The VRE builder database 305 can store data that can control the particular manner in which other data (in the database architecture 300) is used. The VRE builder database can access lower level data shown in the database architecture 300 as needed.

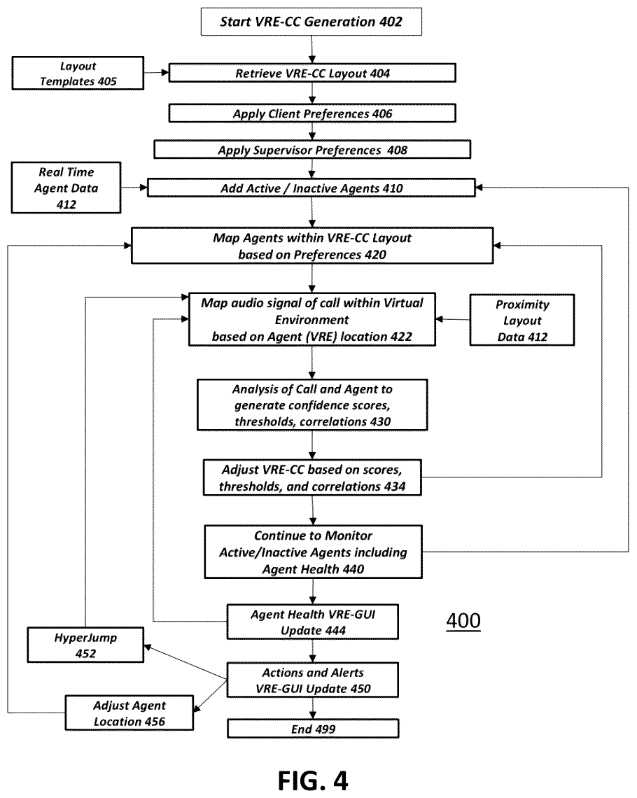

FIG. 4 is a flow diagram illustrating processing performed by the system 200 including the virtual reality generation process 400 performed by the DPI system 200, and in particular the processing system 202, in accordance with at least one embodiment of the disclosure. As shown in FIG. 4, the process is initiated in step 402. In step 402, generation of the virtual reality environment call center (VRE-CC) is initiated. In step 404, the processing system 202 retrieves the VRE-CC layout that is to be used for the particular virtual environment. The particular layout retrieved can be based on various data as otherwise described herein, including client preference, supervisor preferences, the particular product that is the subject of the call center, and/or various other parameters. The processing system 202 can retrieve layout templates, as needed, in step 405. Then, the process passes onto step 406. In step 406, the processing system 202 applies client preferences. Then, in step 408, the processing system 202 applies supervisor preferences and proceeds to 410.

In step 410, the processing system 202 adds both active and inactive agents into the virtual environment. To perform such processing, the processing system 202 can use real-time agent data in the processing of step 412. For example, the processing system 202 can retrieve data indicative of whether an agent is or is not active. The processing system 202 can then use this data in the generation of the virtual environment. After step 410, the process passes onto step 420.

In step 420, the processing system 202 maps agents within the virtual layout based on preferences of the agent, preferences of the supervisor, and/or overall controlling preferences of the virtual call center. Then, in step 422, the processing system 202 maps an audio signal of an incoming call within the virtual environment based on agent location in the virtual environment. In performing such processing, the processing system 202 can utilize proximity layout data, which can be retrieved in step 412. After step 422, the process passes onto step 430.

In step 430, the processing system 202 performs analysis of the call and analysis of the agent to generate confidence scores, thresholds, and correlations between data. Then, in step 434, the processing system 202 adjusts the virtual environment based on the scores, thresholds, and correlations. Then the process passes onto step 440.

In step 440, the processing system 202 continues to monitor the active and inactive agents, including monitoring agent health. Then the process passes onto step 444. In step 444, the processing system 202 updates indicators of the agent health based on new data that has been input. For example, such update can include an update of the agent health visual 109 as shown in FIG. 1. Then, the process passes onto step 450. In step 450, the processing system 202 generates actions and alerts based on newly input data. Such processing can include providing actions and alerts on the customer-agent interface 108, the call health visual 105, and the agent health visual 109.

After step 450 of FIG. 4, the process passes onto step 499. In step 499, the process ends. For example, the process might end at the end of a particular shift or at the end of a workday.

It is appreciated that the sequence of processing as illustrated in FIG. 4 is for purposes of illustration and not limiting. The processing is not limited to the particular serial manner illustrated in FIG. 4. In fact, various of the processing performed by the processing system 202 may be done in parallel to each other. Further, as reflected in FIG. 4, various processing steps can call on other processing steps as needed. In particular, processing steps may call upon or invoke other processing steps as things change within the virtual call center. For example, as the system identifies a change in the active or inactive agents, the processing of step 440 can go back to step 410 so as to add or delete an active agent and/or to add or delete an inactive agent. Also, for example, in the processing of step 450, the processing system 202 can detect that an agent has change location. Accordingly, step 450 can output an alert as to such change in the system, and then the processing system 202 can perform step 456 in which the location of the agent is adjusted. Also, for example, the triggering of actions and alerts can trigger other action to be taken in the system. For example, certain actions and alerts can trigger a hyper jump of the supervisor, in step 452 of FIG. 4, such that the supervisor is aware of a particular situation and able to observe and act on such situation.

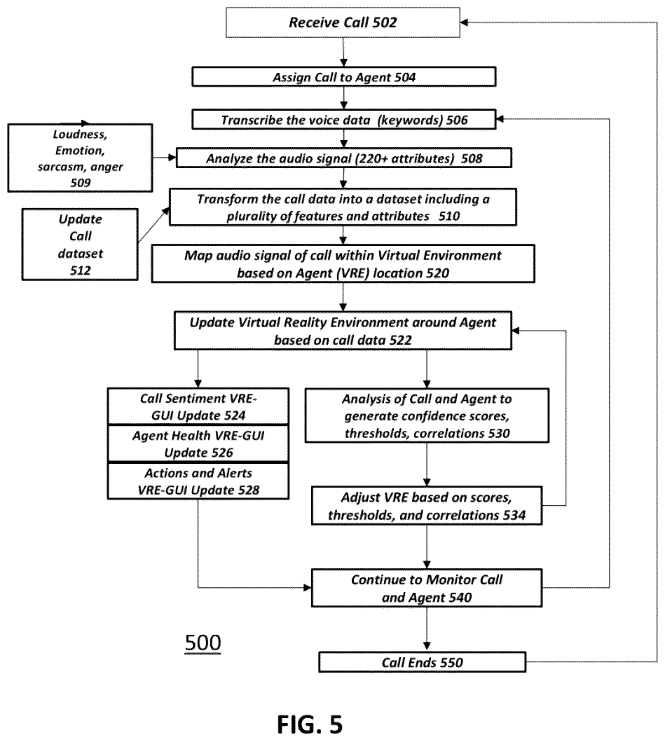

FIG. 5 is a flowchart showing call processing 500 that can be performed by the DPI system 200, and in particular the processing system 202, in accordance with at least one embodiment of the disclosure. As shown in FIG. 5, the process is initiated in step 502. The process of FIG. 5 shows processing that can be performed upon and during a call coming into a call center. More specifically, FIG. 5 shows processing performed upon a call being transferred to a virtual call center environment 100, in accordance with at least one embodiment of the disclosure.

As shown in FIG. 5, a call is received in step 502. Then, in step 504, the processing system 202 assigns a call to a particular agent. Then, the process passes onto step 506. In step 506, the processing system 202 initiates transcription of the call so as to generate voice data. In particular, the processing system 202 can transcribe the call in conjunction with monitoring for a variety of keywords. As described in this disclosure, certain keywords can be mapped to certain action to be taken, upon observation of such keywords. For example, if the term “cancel” is identified (in a call) a certain sequence of processing might be initiated by the processing system 202 or a particular “playbook” or script might be presented to the virtual agent 101.

After step 506, process passes onto step 508. In step 508, the processing system 202 initiates processing to analyze the audio signal, of the call, for a wide variety of attributes. In some embodiments, the call can be analyzed for over 200 attributes. As reflected at 509, such attributes can include loudness of voice, expression of emotion, sarcasm, anger, and various other attributes and permutations of attributes. Such analysis can be applied to both the customer and the agent. Accordingly, such analysis can relate to the loudness of the voice, the intonation of the voice, the pace of speech, the particular words being spoken, particular patterns of words being spoken, as well as various other attributes. Once a known attribute is identified by the processing system 202, the processing system 202 can map such attribute to action to be taken. Such action might include the display of certain information to the agent. After step 508, the process passes onto step 510.

In step 510, the processing system 202 initiates processing to transform call data into a data set that is representative of the call. The data set can include a plurality features and attributes. As reflected on 512, data representing the particular call can be updated during the course of the call to include both the content of the call and a wide variety of attributes associated with such content of the call. Further, various related data can be associated or linked to the particular data of the specific call itself. For example, historical data regarding the particular customer can be linked to the data representing the particular call from that customer. Then, the process passes onto step 520.

In step 520, the processing system 202 maps the audio signal of the call within the virtual environment based on the agent location within the virtual environment. Then, in step 522, the processing system 202 updates the virtual reality environment around the agent based on the call data. Relatedly, the processing system 202 can analyze and update the call sentiment, in conjunction with updating relevant graphical user interfaces (GUIs) including the customer-agent interface 108, the agent health visual 109, and the call health visual 105. The processing system 202 can analyze and update the agent health, in conjunction with updating relevant GUIs including the agent health visual 109. Further, in step 528, the processing system 202 can assess and identify actions and alerts and update relevant GUIs.

With further reference to FIG. 5, in step 530, the processing system 202 can perform analysis of the call in the agent to generate confidence scores, thresholds, and correlations. Further, in step 534, the processing system 202 can adjust the virtual reality environment based on such scores, thresholds, and correlations.

As reflected in step 540 of FIG. 5, the processing system 202 can continue to monitor the call and the agent throughout the course of the call. Once the call ends in step 550, the processing of FIG. 5 can be terminated, for that particular call. It is appreciated that the processing of the disclosure is not limited to the particular sequence of processing illustrated in FIG. 5. Such sequence of processing can be varied as desired. Further, various processing can be performed in serial manner or in parallel manner as desired.

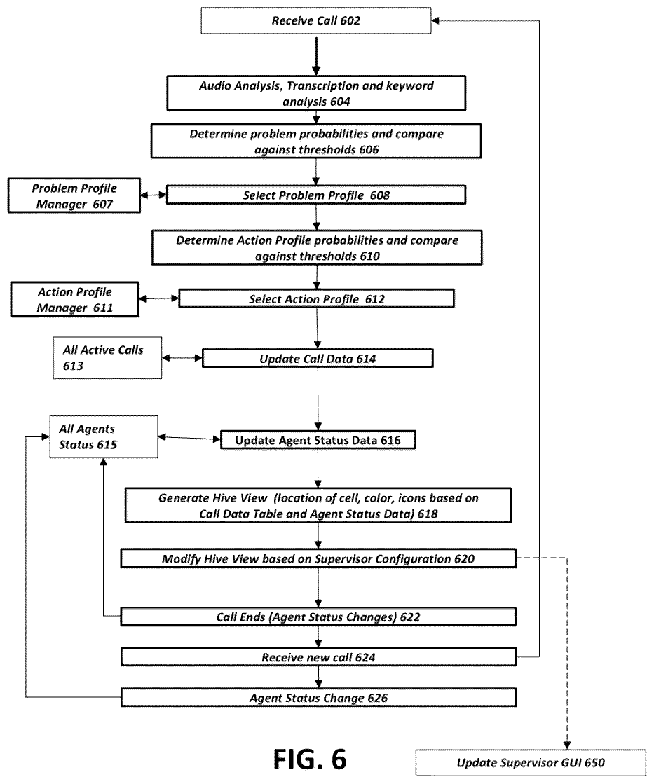

FIG. 6 is a flowchart showing data processing 600 that can be performed by the DPI system 200, and in particular the processing system 202, in accordance with at least one embodiment of the disclosure. The process of FIG. 6 provides further detail regarding analysis of data that is obtained during the course of the call.

As shown in FIG. 6, the process is initiated in step 602. Then, in step 604, audio analysis, transcription, and keyword analysis can be performed by the processing system 202. Such analysis is otherwise described herein. Then, in step 606, the processing system 202 can determine and assess problem probabilities and compare those problem probabilities against thresholds. For example, the processing system 202 can observe data that is then mapped into a known problem. In conjunction with such mapping, the processing system 202 can assess the likelihood that an observed situation, represented by data, does indeed correspond to a known problem. For example, some observed data may be indicative of the known problem, whereas other data is not indicative or goes against the identification of the known problem. Accordingly, thresholds, as well as weightings of different data, can be used to assess the likelihood that an observed situation does indeed correspond to a known problem. Then, the process passes onto step 608. In step 608, the processing system 202 selects a problem profile. The problem profile is representative of a particular known problem, for which the processing system 202 is on the “lookout” for. It is appreciated that there can be many known problems, represented in the system with data, for which the processing system 202 looks for. For example, there can be hundreds or even thousands of problems, represented by data in the database 236, for which the processing system 202 is on the lookout. Each of those problems can be mapped to action items to be performed upon the identification of the particular problem. As shown in FIG. 6, a problem profile manager 607 can perform various processing associated with step 608 and observation of data in a call, mapping of that data to a known problem, and generation of action items, i.e. directives, as a result of the identification of the known problem.

After step 608, the process passes onto step 610. In step 610, the processing system 202 determines action profile probabilities and compares such action profile probabilities against thresholds.

After step 610, the process passes onto step 612. In step 612, the processing system 202 selects an action profile as a result of the processing of step 610. An action profile manager 611 can be provided to perform such processing. Then, in step 614, various call-center data can be updated, including data relating to active calls, as reflected in step 613. Then, the process passes onto step 616. In step 616, the processing system 202 can update the agent status data. Such update may include updating of the agent health visual 109. The process then passes onto step 618.

In step 618, the processing system 202 can generate a “hive” to view. That is, the virtual reality environment of a call center, a collection of agents within a call center, and/or a group of call centers can be described as a “hive”. The processing system 202 can allow a user to access different “views” to display different components of the hive or to display the entire hive. Each of the different views can have different data associated therewith. For example, a view of the overall hive may have more general data displayed, as compared to a view of individual components of the hive. The view of the individual components of the hive may have more detailed data, pertaining to that particular individual component. Further, a user may be able to select which data is displayed and which data is not displayed for a particular view. Further, the processing system 202 can assess credentials of a user and compare such credentials against attributes of some data. That is, higher level access credentials may be required of a user in order to access more confidential or sensitive data.

After step 618, the process passes onto step 620. In step 620, the processing system 202 can modify the hive view based on a selected supervisor configuration, in accordance with at least one embodiment of the disclosure. That is, a supervisor, for example, can be given the ability to modify the hive view including the look and feel of the hive view, as well as data that is displayed in the hive view.

Then, the process passes onto step 622. In step 622, the call ends and, as a result, the status of the agent changes, i.e. the status of the agent handling the call changes. Then, in step 624, the particular agent can receive a new call. As a result, the agent's status again changes in step 626. As reflected at 615 in FIG. 6, the processing system 202 can constantly be monitoring each of the agents status and updating relevant data, including visuals, to represent each of the agent's status. Further, as reflected at 650 of FIG. 6, the GUI of the supervisor can be updated on an ongoing basis so as to accurately represent the status of the call center, and in particular, the portion of the call center that relates to the particular supervisor.

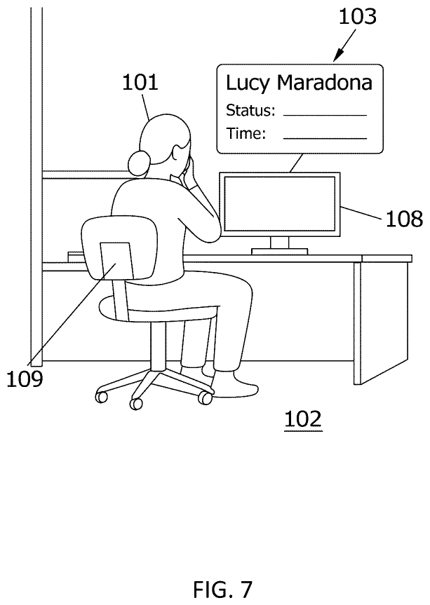

FIG. 7 is a graphical representation of what might be described as a virtual reality environment (VRE) “station” or “workstation” 102. The station 102, as described above, can include a virtual agent 101, a call health visual 103, a customer-agent interface 108, and an agent health visual 109. In particular, FIG. 7 shows details of an illustrative call health visual 103. As shown, the call health visual 103 can display the name of the particular agent. Further, the visual 103 can display the status of the agent. For example, in the illustration of FIG. 7, the agent is “on call”. Further, the call health visual 103 can display a “time” counter that shows how long the particular agent 101 has been on the call as well as the health status of the actual call indicated by indicator 104. It is appreciated that any of a wide variety of additional information can be displayed on the call health visual 103 as may be desired. For example, as the elapsed time of the call gets longer, certain graphical indicia can be displayed so as to represent the length of the call. For example, after a call has gone on for more than 10 minutes, the time counter of the call might be displayed in red versus black.

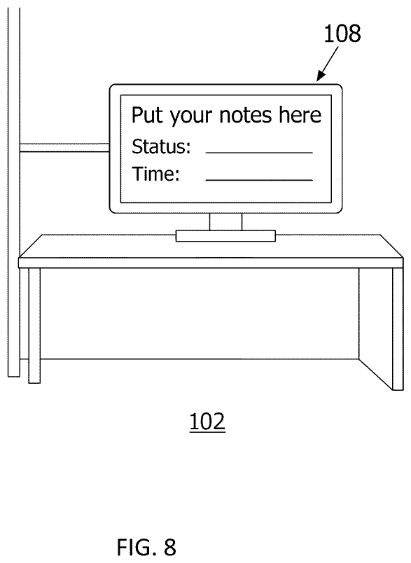

FIG. 8 is a further graphical representation of a workstation 102. In particular, FIG. 8 shows that various information can be displayed on the customer-agent interface 108. For example, the customer-agent interface 108 can be in the form of a laptop or a monitor connected to a computer at the particular workstation 102. As the agent 101 waits for a further call, is engaged in an ongoing call, or has just completed a call, various data can be displayed on the customer-agent interface 108. For example, in the illustrative example of FIG. 8, the agent 101 may have just wrapped up a call and a message to the agent can “pop-up” on the customer-agent interface 108. Generation of such message may have been performed by the processing system 202 in an automated manner. Generation of such message may have been performed in response to a prompt or command by the supervisor, for example.

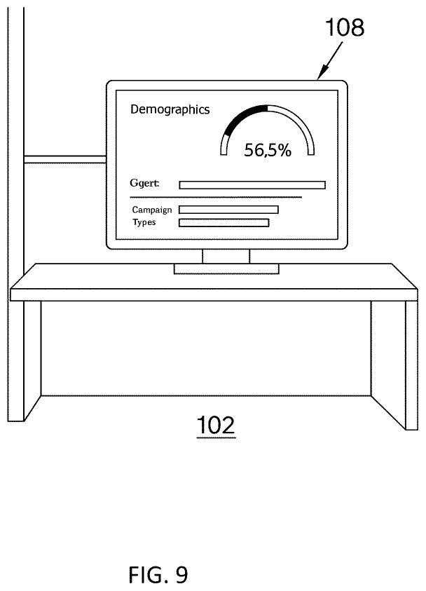

FIG. 9 is a further graphical representation of a workstation 102. In particular, FIG. 9 shows further information which can be displayed on the customer-agent interface 108. For example, such information can include demographics information of the caller. Such further information can include campaign types that the particular agent 101 has worked on. Various data relating to each campaign can be provided.

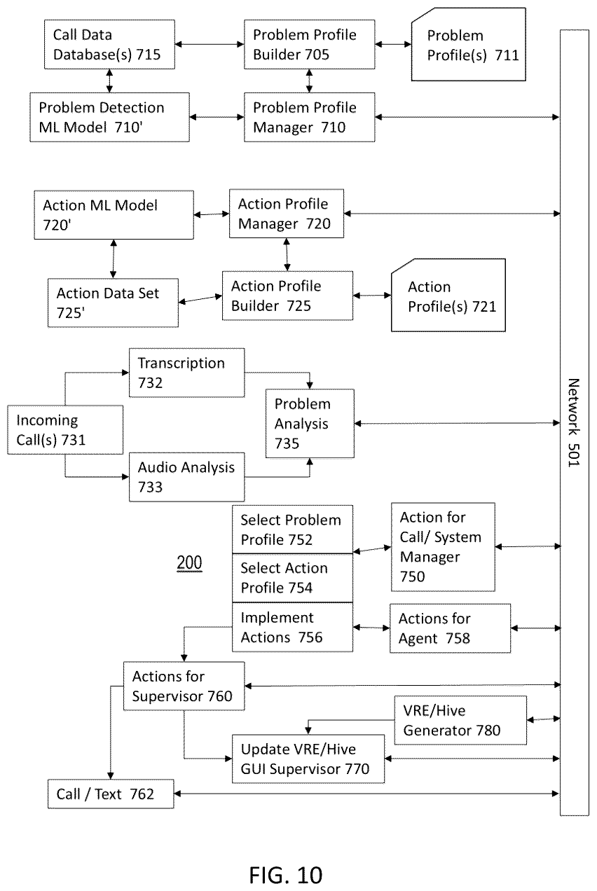

FIG. 10 is a schematic diagram showing various processing components and related processing performed in the DPI system 200. The various processing components and databases of FIG. 10 can be in data communication with each other through a network 501. Such network 501 can be integrated with and/or connected with the network 230 of FIG. 2.

The DPI system 200 can include a problem profile builder 705. The problem profile builder can be connected to a database containing problem profiles 711 and a call data database 715. The problem profile builder 705 can perform various processing using the data in the databases 711, 715. The problem profile builder 705 can also utilize a problem detection machine language (ML) model 710′. The problem profile builder 705 can identify problems and/or receive input regarding an identified problem. The problem profile builder 705 can then assimilate data that is representative of a particular problem. The problem profile builder 705 can then determine solutions to such problem and/or be told by a user what the solution is to the problem, and save or generate data representative of such solution. Accordingly, the problem profile builder 705 can develop, on an ongoing basis, processing methodology and data so as to identify and observe a problem (based on the observation of data indicative of such problem) and provide a solution to such an identified problem. In particular, the data representative of a potential observed problem can be mapped or associated with the solution to such problem, as well as to any other action to be taken in association with such problem. For example, such other action might be the generation of certain alerts or notices to the supervisor, agent, or other entities. As shown in FIG. 10, a problem profile manager 710 can be associated with the problem profile builder 705. The problem profile manager 710 can manage processing performed by the builder 705. For example, the problem profile manager 710 can control and dictate which problems are processed first, which problems from which users are processed first, assign a criticality value to the solution of a problem, generate data regarding the frequency of occurrence of a problem, as well as perform various other processing related to the administration of the problem profile builder 705, data used by the problem profile builder 705, and data generated from operation of the problem profile builder 705.

With further reference to FIG. 10, the DPI system 200 can include an action profile builder 725. The action profile builder 725 can be connected to a database containing action profiles 721 and an action data set 725′. The action profile builder 725 can perform various processing using the data in the databases 721, 725′. The action profile builder 725 can utilize an action ML model 720′. The action profile builder 725 can receive requests from the problem profile builder 705 with regard to required action to be performed or parameters associated with action to be performed. Based on input parameters, the action profile builder 725 can build out action sequences to be performed upon the occurrence of a certain event being observed. For example, the action profile builder 725 may be provided with data representing a certain required action and be tasked with developing a processing sequence, in the virtual environment, to actually execute on that certain required action. The action profile builder 725 can be associated with a action profile manager 720. The action profile manager 720 can manage processing performed by the action profile builder 725. For example, the action profile manager 720 can control and dictate which action generation tasks are processed first, which problems from which users are processed first, assign a criticality value to the generation of particular action, and generate data regarding how often or frequency at which a generated action should be executed.

With further reference to FIG. 10, the DPI system 200 can perform various processing as reflected in FIG. 10 and as described herein. The DPI system 200 can perform processing in step 732 to generate transcription from a call. Problem analysis processing 735 can perform various processing associated with the analysis of a problem. Audio analysis processing 733 can perform various processing associated with analysis of audio data observed in a call, including audio data from the customer and audio data from the agent. Further, incoming calls processing 731 can perform various processing associated with an incoming call. For example, the incoming calls processing 731 can identify attributes of an incoming call, generate a profile to capture such attributes of an incoming call, categorize the incoming call, and assign the incoming call to an agent based on the categorization of the incoming call.

FIG. 10 also illustrates various action and associated processing including actions 750 for a call manager or system manager; actions 760 for a supervisor; and actions 758 for an agent. For example, actions that can be performed by a call manager or system manager 750 can include to select a problem profile to work with in step 752 and to select an action profile to work with in step 754. For example, the system manager might select a problem profile in the processing of step 752, review the attributes of such problem profile, determine how often the problem profile is being utilized, determine how effectively the problem profile is being utilized, determine the success rate of such problem profile, and control whether the problem profile is continued to be used or whether the problem profile is discontinued based on lack of success or other shortcomings associated with the particular problem profile.

With further reference to FIG. 10, as referenced in step 756, various actions can be selected by the agent and/or the supervisor for execution. For example, an agent may observe a particular situation developing in a call and be aware of an available action that might be of assistance to such developing situation. Accordingly, the agent can interface with the processing system 202 so as to execute on such action. For example, such action for execution might include the retrieval of certain data or text content that might be useful in a call. In at least one embodiment of the disclosure, text content that is so retrieved might be revised or custom tailored to the particular situation at hand, including, for example, the particular customer. In one example, text content that is retrieved to be helpful to a call could be populated with the particular name of the customer, so as to assist the agent in more effectively and seamlessly communicating with the customer. However, text content that is retrieved and presented to an agent in a certain situation can be more complex. For example, text content that is retrieved and revised could be populated with technical information that relates to the particular call at hand.

With further reference to FIG. 10, a supervisor may be provided with call or text functionalities as reflected at 762. For example, a supervisor can be provided with the ability to text, call, or communicate over some other communication channel with an agent in the particular supervisor's group, a plurality of agents, and/or an administrative entity, for example. Further, various processing can be performed to update the user interface of the supervisor. That is, the GUI of the supervisor can be updated in various ways to include various information. The processing system 202 may automatically update the supervisor's GUI, the supervisor may interface with the processing system 202 so as to request an update, the supervisor's GUI can be updated upon the occurrence of a particular event and/or at the occurrence of a particular periodicity. For example, the supervisor's GUI might be updated every hour, every 15 minutes, upon an agent's status being changed from active to inactive, and/or upon the occurrence of any other event, as may be desired. As reflected in FIG. 10, the update of the supervisor's GUI, VRE or Hive, can be performed and/or interface with data from the VRE/Hive generator 780. That is, the VRE/Hive generator 780 or processing component thereof can perform various processing associated with generation of the VRE or hive as described herein. Various features of such generation of the hive can affect the operating parameters of a supervisor. As result, operating parameters associated with the generation of the VRE or hive and changes in such operating parameters can be presented to the supervisor, via the supervisor's GUI through the Update of the VRE/Hive GUI as reflected at 770. As a result, the supervisor can be privy to ongoing changes in the construct of the hive.

Hereinafter, various further features of the DPI system 200 and the virtual environment that is created by the DPI system 200 will be described.

As described herein, each of the agents can be provided with a customer-agent interface 208. The customer-agent interface 208 can include a virtual reality headset. The VR headset can be a device that user wears over the user's eyes, in a similar manner to a pair of goggles. The VR headset provides a 3D experience in that the user is provided, in their field of vision, with imagery that simulates a real 3D environment. The VR headset can use various known technology including 3D near-eye displays. In accordance with some embodiments of the disclosure, for example, the “Apple Vision Pro” or the “Meta Quest 2”, or a modified version thereof, might be used as a headset to provide the customer-agent interface 108. For example, a VR headset in accordance with the disclosure can provide a total immersive visual experience with 3D positional audio. In accordance with the present disclosure, both the supervisor and the various agents can be provided with a respective VR headset so that each of such supervisor and agents can be immersed in the virtual reality environment provided by the DPI system.

Various features can be provided to both the supervisor and the agents. User interfaces can be provided to the supervisor and agent so that they can control a particular feature, opt into a particular feature, opt out of a particular feature, and/or otherwise control the use of a feature. In conjunction with providing 3D positional audio, the supervisor can opt to hear all of the calls of the various agents, which the supervisor supervises. Alternatively, the supervisor can opt to only hear one call for one of their agents. The supervisor might opt to only hear a certain type of call. For example, the user interface may be provided to the supervisor so that they can select to only hear calls that relate to cancellations.

As described herein, the DPI system 200 can input various attributes so as to monitor the health of the agent. Such attributes can include the identity of the agent, the profile of the agent, performance statistics of the agent, the engagement details of the agent, mental health attributes of the agent, and a determination of churn risk of the agent. That is, how likely is it that a particular agent chooses to leave their position. Based on such data, a supervisor can tailor the supervisors action and behavior to a particular agent. The supervisor can be provided with particular capabilities. The supervisor can generate and output a note to one or more of the agents who work beneath a particular supervisor, for example.

The DPI system 200 can include various features directed to monitoring the health of the call center and outputting data representative of the health of the call center. The monitoring the health of the call center can be based on various parameters including call data, analytics based on observed calls, agent health, external factors, market factors, environment factors, as well as other parameters that may impact the health of the call center.

As described herein, the DPI system 200 can input data and, based on such data, generate agent health information. The agent health information can be displayed via an agent health visual 109, which is reviewable by the supervisor in the virtual environment. The monitoring of the agent health can be based on various parameters including attributes of a particular client on a call, the type of call, the duration of the call, the agent data, biographical data regarding the agent, experience of the agent, training of the agent, the particular playbook or script being used by the agent, and the occurrence of breaks taken by the agent.

As otherwise described herein, the processing of the DPI system 200 can include the use of what may be described as “playbooks”. A playbook can include rules applicable to an agent and actions to be taken upon observation of a certain event, for example. A myriad of playbooks can be generated, respectively, for a wide variety of problems that can be encountered by the agent. Upon a problem being identified, in a call between an agent and a customer, the processing system 202 can suggest a particular playbook to the agent. In conjunction with the suggestion of a particular playbook, the processing system 202 can provide a confidence score. The confidence score can represent how certain the processing system 202 is that a certain action should be taken. Accordingly, if the confidence score is high in a particular situation, then the agent may well want to take such action (or indeed be dictated to take such action). However, if the confidence score is low, then the agent should and may well have more discretion to ignore the proposed course of action, i.e. to ignore the proposed playbook. Such playbooks of the disclosure can encompass both playbooks, i.e. actions, for agents and trigger actions for a supervisor. Suggested action for the agent or supervisor can be communicated via the customer-agent interface 108 of the agent, which can be in the form of a VR headset.

In accordance with the disclosure, a VR headset can be provided with image input mechanisms, including cameras, that can input data regarding attributes of an agent or supervisor's face. That is, facial recognition and processing can be performed so as to input additional data regarding the supervisor or agent. Such input data can include face gestures, eye rolling, or other facial attributes. Such input data, such as the observation of a particular facial expression or the observation of a sequence of facial expressions can be mapped to the likelihood of certain events occurring. For example, certain face gestures and eye rolling can be a good predictor of a declining call. Such input data can be considered as a factor in the triggering of various processing being performed, including an alert that a supervisor should “dial in” to the particular agent's call.

The observation of a certain event can trigger an alert to the agent and/or the supervisor. For example, such alert can be displayed to the user or agent via their VR headset. Communications to the agent or supervisor can be performed via text, email or other communication channel.

Upon the observation of a certain event occurring, the processing system 202 can map the observed data to data sets. Each of the data sets can correspond to a particular possible problem. There can be tens, hundreds, or thousands of data sets that each represent a particular problem. In such a mapping of the observed data to possible problems, various processing techniques can be utilized. For example, some data can be weighted more than other data. Further, thresholds can be utilized. For example, certain processing might only be initiated upon the observation of a certain volume level in a call. Further, processing can be used in which certain attributes are ranked above other attributes. In general, various processing methodologies can be used so as to determine the best match between observed data and a known problem, to which such data can be mapped. Once the known problem is identified, then solutions can be presented to the agent (or supervisor) including a particular playbook to be utilized or suggested to the agent.

In general, the processing system 202 can monitor the many attributes of the system and observe changes to such attributes. Changes to such attributes can result in certain action being taken. For example, a change in a particular attribute can result in an alert being sent to the agent or supervisor. The processing of changes can utilize thresholds, correlations between data, weighting of different data, and preferences of the supervisor profile. For example, a supervisor may be provided the ability to control what attributes are looked at in deciding, by the system, whether to perform or not to perform certain action. For example, the supervisor might control what attributes are utilized when the system considers whether a particular agent is provided with a commendation or award.

### Audio Control Features

In certain embodiments, the system may further include audio control features configured to enhance supervisor awareness and interaction. For example, the system may present spatial audio within the virtual environment such that the relative loudness of an agent's call corresponds to the agent's position in the VR layout. In some embodiments, supervisors may enable a whisper mode to privately communicate with a selected agent, or a group audio mode to address multiple agents simultaneously. The system may further vary audio properties based on sentiment detection, for instance increasing volume or urgency indicators when negative sentiment (e.g., anger, sarcasm, frustration) is detected, or reducing volume when a call is proceeding satisfactorily.

### Supervisor Tools

In additional embodiments, the system may incorporate interactive supervisor tools within the VR interface. Supervisors may leave persistent virtual notes on an agent's workstation, initiate barge-in or coaching modes to join an active call, or utilize scoring clipboards to evaluate call quality. In some cases, multiple supervisors may engage in joint coaching sessions, collaboratively reviewing agent performance in real time. The system may also enable supervisors to provide instant rewards or feedback to agents, such as visual tokens or badges displayed within the VR environment to reinforce positive behaviors.

### Agent Health

The system may further incorporate expanded agent health and churn analysis. In one embodiment, the VR panels associated with each agent (e.g., panels 109, 119, 129) may display not only physiological data but also predictive indicators of mental health, stress, or churn risk. Such indicators may be derived from machine learning models that analyze speech patterns, historical performance data, or call sentiment. This allows supervisors to proactively address potential burnout or attrition.

In certain embodiments, the system may employ multi-layer AI/ML analysis to generate composite scoring. For example, the problem profile subsystem and action profile subsystem may each generate independent confidence scores, which may then be compared against multiple thresholds or analyzed in correlation to identify emerging issues. The system may further present machine scoring overlays within the VR environment, such as colored highlights or annotations superimposed on agent avatars, panels, or call data.

In alternative embodiments, the system may support layout variations and supervisory hierarchies. For example, a Supervisor-of-Supervisors view may provide a meta-level VR environment in which higher-level managers monitor multiple supervisors simultaneously. The system may also enable color variance of avatars or workstation cubes to visually distinguish call types, agent states, or escalation levels.

### Dynamic Reconfiguration of Layout

In some embodiments, the system is further configured to dynamically reconfigure the layout of the virtual workstations within the virtual call center environment. For example, the processing system may reposition one or more virtual workstations based on real-time analysis of call data, agent performance, supervisory preferences, or commands. In certain cases, agents experiencing difficulties may be grouped into a focused area of the virtual environment, enabling the supervisor to virtually navigate to that area for closer monitoring, coaching, or intervention. Dynamic reconfiguration may occur automatically in response to detected conditions, or manually under supervisor control, and may include resizing, rearranging, or clustering workstations to optimize supervisory oversight. Layouts may be dynamically reconfigured, with supervisors able to “hyper-jump” between views of individual agents, groups of agents, or system-wide perspectives.

The phrase “real time” is used in this disclosure. Such phrase, as used herein, means that there is no noticeable or observable delay, by a human observer, between the action and the affect or consequence of the action.

It is appreciated that various embodiments are described herein. It is appreciated that a particular feature of a particular embodiment described herein might be utilized in other embodiments described herein, as desired.

The various components of embodiments of the disclosure may be made from any of a variety of materials including, for example, stainless steel, plastic, plastic resin, nylon, metal, aluminum, composite material, foam, rubber, wood, and/or ceramic, for example, any material described in this disclosure and/or any other material as may be desired. For example, the systems(s) of this disclosure and the various components that make up the systems of the disclosure could be manufactured as extruded aluminum with regard to the metal components used in the system of the disclosure and/or from injection molding techniques with regard to the plastic components used in the system of the disclosure.

A variety of production techniques may be used to make the apparatuses as described herein. For example, suitable injection molding, other molding techniques, casting, injection casting and/or any other manufacturing techniques might be utilized. Also, the various components of the apparatuses may be integrally formed, as may be desired, in particular when using molding construction techniques. Also, the various components of the apparatuses may be formed in pieces and connected together in some manner, such as with welding.

The various apparatuses and components of the apparatuses, as described herein, may be provided in various sizes and/or dimensions, as desired.

It will be appreciated that features, elements and/or characteristics described with respect to one embodiment of the disclosure may be variously used and combined with other embodiments of the disclosure as may be desired.

In this disclosure, quotation marks, such as with “connection portion”, have been used to enhance readability and/or to parse out a term or phrase for clarity.

It will be appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present.

It will be understood that when an element or layer is referred to as being “onto” another element or layer, the element or layer can be directly on another element or layer or intervening elements or layers. Examples include “attached onto”, secured onto”, and “provided onto”. In contrast, when an element is referred to as being “directly onto” another element or layer, there are no intervening elements or layers present. As used herein, “onto” and “on to” have been used interchangeably.

It will be understood that when an element or layer is referred to as being “attached to” another element or layer, the element or layer can be directly attached to the another element or layer or intervening elements or layers. In contrast, when an element is referred to as being “attached directly to” another element or layer, there are no intervening elements or layers present. It will be understood that such relationship also is to be understood with regard to: “secured to” versus “secured directly to”; “provided to” versus “provided directly to”; and similar language.

As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “upper”, “top”, “bottom”, “left”, “right”, “forward”, “back”, “inner”, “outer”, “front”, “back” and the like, may be used herein for ease of description to describe the relationship of one element or feature to another element(s) or feature(s) as illustrated in the drawing figures. It will be understood that spatially relative terms are intended to encompass different orientations of structures in use or operation, in addition to the orientation depicted in the drawing figures. For example, if a device in the drawing figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to diagrams and/or cross-section illustrations, for example, that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of components illustrated herein but are to include deviations in shapes that result, for example, from manufacturing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

Embodiments are also intended to include or otherwise cover methods of using and methods of manufacturing any or all of the elements disclosed above.

While the subject matter has been described in detail with reference to exemplary embodiments thereof, it will be apparent to one skilled in the art that various changes can be made, and equivalents employed, without departing from the scope of the disclosure.

All related art references discussed in the above Background section are hereby incorporated by reference in their entirety. All documents referenced herein are hereby incorporated by reference in their entirety.

As described herein, in at least some embodiments of the system of the disclosure, various processes are described as being performed by one or more computer processors. Such one or more computer processors can, in conjunction with a database or other data storage mechanism, provide and/or constitute a “processing machine,” i.e. a tangibly embodied machine, in that such one or more computer processors can include various physical computing devices as otherwise described herein, various support structure to physically support the computing devices, other hardware, and other physical structure, for example. In embodiments, a processing machine of the disclosure can include one or more computer processors and one or more databases that are in communication with the one or more computer processors. A computer processor or processing machine of the disclosure can be part of a higher level system or apparatus. As described herein, “tangibly embodied” means that one can physically touch the particular item.

As used herein, the term “computer processor” can be understood to include at least one processor that uses at least one memory. The at least one memory can store a set of instructions. The instructions may be either permanently or temporarily stored in the memory or memories of the processing machine or associated with the processing machine. The computer processor can execute the instructions that are stored in the memory or memories in order to process data, input data, output data, and perform related processing. The set of instructions may include various instructions that perform a particular task or tasks, such as any of the processing as described herein. Such a set of instructions for performing a particular task may be described as a program, software program, code or simply software. Accordingly, various processing is described herein as performed by a computer processor (CP). Such computer processor (CP) can be described as or can include: a computer processor portion, a computer processing portion, a processor, a system processor, a processing system, a server, a server processing portion, an engine, a processing engine, a central processing unit (CPU), a controller, a processor-based controller, an electronic computing device, an apparatus controller, an apparatus computer processor, a processing device, a computer operating system, an apparatus processing portion, an apparatus processing portion, an electronic control unit (“ECU”), a microcontroller, a microcomputer, a plurality of electronic computing devices or servers, other processor-based controller(s), and/or similar constructs, for example.

A computer processor and/or processing machine, of the disclosure, may be constituted by and/or be part of particular apparatus(es), system(s) and/or device(s) described herein. The computer processor can execute instructions that are stored in memory or memories to process data. This processing of data may be in response to commands by a user or users of the computer processor, in response to previous processing, in response to a request by another processing machine and/or any other input, for example. A user can be in the form of a user device, such as a cellular phone.

A computer processor and/or processing machine of the disclosure may also utilize (or be in the form of) any of a wide variety of technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that can be capable of implementing the steps of the processes of the disclosure.

The computer processor and/or processing machine used to implement the disclosure may utilize a suitable operating system. Thus, embodiments of the disclosure may include a processing machine running the Windows 11 operating system, the Windows 10 operating system, the Windows 8 operating system, Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the disclosure as described herein, it is not necessary that the computer processors and/or the memories of a processing machine be physically located in the same geographical place. That is, each of the computer processors and the memories used by the processing machine may be located in geographically distinct locations and connected so as to communicate in any suitable manner. Additionally, it is appreciated that each computer processor and/or the memory may be composed of different physical pieces of equipment. Accordingly, it is not necessary that a processor be one single piece of equipment in one location and that the memory be another single piece of equipment in another location. That is, it is contemplated that the processor may be two pieces of equipment in two different physical locations. The two distinct pieces of equipment may be connected and in communication with each other in any suitable manner. Additionally, the memory may include two or more portions of memory in two or more physical locations.

To explain further, processing as described above can be performed by various processing components and various memories. However, it is appreciated that the processing performed by two distinct components as described herein may, in accordance with a further embodiment of the disclosure, be performed by a single component. Further, the processing performed by one distinct component as described above may be performed by two distinct components. For example, processing as described herein might be performed in part by a system or other system or server, in part by some third party resource, and in part by a user device. In a similar manner, the memory storage performed by two distinct memory portions as described herein may, in accordance with a further embodiment of the disclosure, be performed by a single memory portion. Further, the memory storage performed by one distinct memory portion as described above may be performed by two memory portions.

Further, as described herein, various technologies may be used to provide communication between the various processors and/or memories, as well as to allow the processors and/or the memories of the disclosure to communicate with any other entity; i.e., so as to obtain further instructions, transfer data, or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described herein, a set of instructions can be used in the processing of the disclosure on the processing machine, for example. The set of instructions may be in the form of a program or software to perform the processing as described herein. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

It is appreciated that the instructions or set of instructions used in the implementation and operation of features of the disclosure may be in a suitable form such that a computer processor or processing machine may read the instructions. For example, the instructions that form a program may be in the form of a suitable programming language, which can be converted to machine language or object code to allow the processor or processors to read the instructions. That is, written lines of programming code or source code, in a particular programming language, can be converted to machine language using a compiler, assembler or interpreter. The machine language can be binary coded machine instructions that are specific to a particular type of processing machine, i.e., to a particular type of computer processor, for example. The computer processor understands the machine language.

Accordingly, a suitable programming language may be used in accordance with the various embodiments of the disclosure. Illustratively, the programming language used may include assembly language, Ada, APL, Basic, C, C++, COBOL, dBase, Forth, Fortran, Java, Modula-2, Pascal, Prolog, REXX, Visual Basic, Python, Ruby, PHP, Perl, JavaScript, and/or other scripting language, for example. Further, it is not necessary that a single type of instructions or single programming language be utilized in conjunction with the operation of the systems and methods of the disclosure. Rather, any number of different programming languages may be utilized as may be necessary or desirable.

Also, the instructions and/or data used in the practice of the disclosure may utilize any compression or encryption technique or algorithm, as may be desired. An encryption module might be used to encrypt data. Further, files or other data may be decrypted using a suitable decryption module, for example. Accordingly, a compression or encryption technique or algorithm can be used that transforms the data from an un-encrypted format to an encrypted format.

As described above, the disclosure may illustratively be embodied in the form of a processing machine, including a computer processor, for example, that includes at least one memory. It is to be appreciated that the set of instructions, i.e., the software for example, that enables the computer processor to perform the operations described herein may be contained on any of a wide variety of media or medium, as desired. Further, the data that can be processed by the set of instructions can be contained on any of a wide variety of media or medium. That is, the particular medium, i.e., the memory or data storage device used in a processing machine, utilized to hold the set of instructions and/or the data used in practice of the disclosure may take on any of a variety of physical forms or transmissions, for example. Illustratively, the medium or data storage device may be in a tangibly embodied form of paper, paper transparencies, a compact disk, a DVD, an integrated circuit, a hard disk, a floppy disk, an optical disk, a magnetic tape, a RAM, a ROM, a PROM, a EPROM, a CD-ROM, a DVD-ROM, a hard drive, a magnetic tape cassette, a wire, a cable, a fiber, communications channel, and/or may be in the form of a satellite transmissions or other remote transmission, as well as any other medium or source of data that may be read by the processors of the disclosure.

For example, exemplary embodiments are intended to cover all software or computer programs capable of enabling processors to implement the operations, designs and determinations as described herein. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed herein.

These computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs and outputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. A network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

The database(s), memory or memories used in the processing machine that implements the disclosure may be in any of a wide variety of forms to allow the memory to hold instructions, data, or other information, as can be desired. Thus, a memory might be in the form of a database to hold data. The database might use any desired arrangement of files or data sets such as a flat file arrangement or a relational database arrangement, for example. The database can include any number of data records, tables, and/or other data structure. A table in a database can include a Primary key (PK) to identify the table. A foreign key (FK) can be an attribute in one table (entity) that links or maps to the PK of another table, so as to provide an interrelationship or mapping between tables and/or databases, for example.

In various processing described herein and illustrated by flowcharts or otherwise described, variables can be used in various processes. Such processes can include routines, subroutines, and steps, for example. The various variables can be passed between processes as may be needed in accord with the instructions provided to a processor. The various variables can be global variables that are available to all the various processes, such as between a calling process and a subroutine, for example.

In the system and method of the disclosure, a variety of “user interfaces” may be utilized to allow a user to interface with the processing machine or machines that are used to implement the disclosure. As used herein, a user interface can include any hardware, software, or combination of hardware and software used by the processing machine that allows a user to interact with the processing machine and/or computer processor. A user interface may be in the form of a dialogue screen for example. A user interface may also include any of a mouse, touch screen, keyboard, voice reader, voice recognizer, dialogue screen, menu box, list, checkbox, toggle switch, a light, a pushbutton or any other device that allows a user to receive information regarding the operation of the processing machine as the processing machine processes a set of instructions and/or provide the processing machine with information. Accordingly, the user interface can be any device that provides communication between a user and a processing machine and/or computer processor. The information provided by the user to the processing machine through the user interface may be in the form of a command, a selection of data, or some other input, for example.

A user interface of the disclosure can be provided by or in the form of a user device or electronic user device. Also, systems of the disclosure can include or be in communication with one or more user devices that serve to interact or interface with a human user. A user device can be any appropriate electronic device, such as a cellular (mobile) telephone, smart phone, a tablet computer, a laptop computer, a desktop computer, an e-reader, an electronic wearable, smartwatch, gaming console, personal digital assistant (PDA), portable music player, fitness trackers with smart capabilities, and/or a server terminal, for example.

Such a user device can permit a user to input requests for information, output information, and/or process data. A user device can be in the form of and/or include a computer processor and/or a processing machine, as described herein.

As discussed above, a user interface can be utilized by the processing machine, which performs a set of instructions, such that the processing machine processes data for a user. The user interface can be typically used by the processing machine for interacting with a user either to convey information or receive information from the user. However, it should be appreciated that in accordance with some embodiments of the systems and methods of the disclosure, it is not necessary that a human user actually interact with a user interface used by the processing machine of the disclosure. Rather, it is also contemplated that the user interface of the disclosure might interact, i.e., convey and receive information, with another processing machine, rather than a human user. Accordingly, the other processing machine might be described as a user. Further, it is contemplated that a user interface utilized in the systems and methods of the disclosure may interact partially with another processing machine or processing machines, while also interacting partially with a human user.

As used herein, “data” and “information” have been used interchangeably.

In conclusion, it will be readily understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

We claim:

1. A system comprising:
a processing system configured to generate a virtual call center environment including a plurality of virtual workstations, each virtual workstation associated with a respective call agent;
the processing system further configured to receive audio data from active calls of the respective call agents;
the processing system further configured to spatially map the audio data from the active calls to positions of the corresponding virtual workstations within the virtual call center environment; and
the processing system further configured to enable a supervisor to navigate the virtual call center environment such that the supervisor hears the audio data corresponding to one or more virtual workstations based on a virtual position of the supervisor within the virtual call center environment.

2. The system of claim 1, wherein the processing system is further configured to dynamically reconfigure a layout of the virtual workstations based on real-time analysis of the active calls or performance of the call agents.

3. The system of claim 2, wherein the dynamic reconfiguration includes grouping selected call agents into a common area of the virtual call center environment for enhanced supervisory monitoring or training.

4. The system of claim 1, wherein the audio data is spatialized such that a perceived loudness or direction of a call corresponds to the virtual position of the associated workstation relative to the virtual position of the supervisor.

5. The system of claim 1, wherein the processing system further generates visual panels associated with the virtual workstations, each panel displaying real-time call information or agent status data.

6. A method for supervising call center operations in a virtual environment, the method comprising:
generating, by a processing system, a virtual call center environment including a plurality of virtual workstations, each virtual workstation associated with a respective call agent;
receiving audio data from active calls of the respective call agents;
spatially mapping the audio data from the active calls to positions of the corresponding virtual workstations within the virtual call center environment; and
enabling a supervisor to navigate the virtual call center environment such that the supervisor hears the audio data corresponding to one or more virtual workstations based on a virtual position of the supervisor within the virtual call center environment.

7. The method of claim 6, further comprising dynamically reconfiguring a layout of the virtual workstations based on real-time analysis of the active calls or performance of the call agents.

8. The method of claim 7, wherein dynamically reconfiguring includes grouping selected call agents into a common area of the virtual call center environment for enhanced supervisory monitoring or training.

9. The method of claim 6, wherein spatially mapping includes rendering the audio data such that a perceived loudness or direction of a call corresponds to the virtual position of the associated workstation relative to the virtual position of the supervisor.

10. The method of claim 6, further comprising generating visual panels associated with the virtual workstations, each panel displaying real-time call information or agent status data.

11. A non-transitory computer-readable medium storing instructions that, when executed by one or more processors, cause the processors to:
generate a virtual call center environment including a plurality of virtual workstations, each virtual workstation associated with a respective call agent;
receive audio data from active calls of the respective call agents;
spatially map the audio data from the active calls to positions of the corresponding virtual workstations within the virtual call center environment; and
enable a supervisor to navigate the virtual call center environment such that the supervisor hears the audio data corresponding to one or more virtual workstations based on a virtual position of the supervisor within the virtual call center environment.

12. The non-transitory computer-readable medium of claim 11, wherein the instructions further cause the processors to dynamically reconfigure a layout of the virtual workstations based on real-time analysis of the active calls or performance of the call agents.

13. The non-transitory computer-readable medium of claim 12, wherein the dynamic reconfiguration includes grouping selected call agents into a common area of the virtual call center environment for enhanced supervisory monitoring or training.

14. The non-transitory computer-readable medium of claim 11, wherein spatially mapping includes rendering the audio data such that a perceived loudness or direction of a call corresponds to the virtual position of the associated workstation relative to the virtual position of the supervisor.

15. The non-transitory computer-readable medium of claim 11, wherein the instructions further cause the processors to generate visual panels associated with the virtual workstations, each panel displaying real-time call information or agent status data.
